(19) United States
(12) Patent Application Publication
(10) Pub. No.: US 2002/0184124 A1
(43) Pub. Date: Dec. 5, 2002

(54) Securities tickets

(76) Inventor: Alexander Liss, New York, NY (US)

Correspondence Address: ALEXANDER LISS, 333 E 66 ST APT 5C, NEW YORK, NY, 10021, US

(21) Appl. No.: 09/681,774

(22) Filed: Jun. 3, 2001

(51) Int. Cl. G06F 17/60

(52) U.S. Cl. 705/35

(57) ABSTRACT

Financial instruments: a Conversion Securities Ticket and a Dividend Securities Ticket, which serve as representatives of a future state of a securities or currency holding during the process of transformation of this holding (as stock split, currency conversion, dividend payment, etc.); they can be divided and aggregated, they can have a cryptographic signature of a special entity and they participate in trade; their granting is prompted by a Notification and the transformation is prompted by a second Notification and is made based on Securities Tickets' information.

### BACKGROUND OF INVENTION

The invention uses well known methods of cryptographic signing (see for example, A. Menezes, P. Oorschot, Scott Vanstone Handbook of Applied Cryptography, CRC Press, 1997).

### SUMMARY OF INVENTION

A security holding or a currency holding sometimes undergoes a transformation initiated by an issuer of this type of holding, for example securities split, currency conversion, dividend payment, etc. Often, this transformation stretches over a period, when this holding is not fully available for trade. The solution is in introduction of a special financial instrument—a Securities Ticket, which is used by trading parties to

present a state of a holding after this transformation during the period of this transformation

be used to finalize this transformation.

Securities Tickets can be split (subject to limitations) and some of them can be aggregated.

When the transformation is a conversion as securities split, where an old version of security holding is converted to a new one with a different amount and possibly some cash to compensate for a fraction of a share, or as a currency conversion, a Conversion Securities Ticket is used. The Conversion Securities Ticket is split as a holding is split, for example during a trade, and it is transferred as an associated holding is transferred. It carries information about associated security or currency and about its conversion.

When the transformation is an addition to existing holding on a basis of a qualified historical record of an Account, where this holding is recorded, for example a dividend or interest payment, a Dividend Securities Ticket is used. The Dividend Securities Ticket can be split and transferred independently. However, its split is a subject to limitations, for example each portion should represent a dividend paid for a whole number of shares; or for example if a dividend is paid in shares, then a Dividend Securities Ticket should represent a dividend payment, which corresponds to a whole number of paid shares.

Technically, Securities Tickets are records in Accounts, which are managed by special software modules—Ticket Managers, which introduce these records, change them, when Securities Tickets are split or aggregated, and change records related to associated security or currency, when the transformation is finalized. A Ticket Manager manages a group of accounts. Activity of Ticket Managers is synchronized with the transformation process using Notifications, which are sent to them. A First Notification prompts them to grant Securities Tickets, and a Second Notification prompt them to finalize the transformation. All actions of Ticket Managers are performed as transactions.

A special (business) entity can participate in the Securities Tickets management. In this case, each time a Securities Ticket is created, as an original Securities Ticket or as a result of a Securities Ticket split or a result of Securities Tickets aggregation, this entity cryptographically signs Security Tickets and it keeps records of Securities Tickets creation. This entity participates in the final transformation—it provides a new version of holdings, facilitates payment of dividends or interest, etc.

### DETAILED DESCRIPTION

Holders of securities—shareholders, bondholders, etc., sometimes encounter conversion of their holdings as split of stock, dividend payments (in cash or in stock) or interest payment. Holders of currency sometimes encounter conversion of the type of their currency. Often, there is a time lag between the moment, when such conversion or dividend payment is in effect, and the moment, when a holder of securities or currency has a full possession of a new holding. Usually, this time lag occurs, because their agent (a bank, a broker, etc.) have not finalized the process of conversion or the process of receiving of dividends. In this period, either the security or currency cannot be traded in a usual way or the dividend is not available for the trade. This impedes the trade.

A solution is in the introduction of a new financial instrument—a divisible Securities Ticket: a Conversion Securities Ticket and a Dividend Securities Ticket.

A subject of conversion is a holding at hand. A Conversion Security Ticket carries information about a type and a moment of pending conversion (a moment of activation). It can carry also some additional information. It is divisible, because it can be split into a few Tickets, which sum represents an original one. This allows an immediate trade of securities or currency, which are subject to conversion—they are traded together with their Conversion Securities Tickets.

In the moment the conversion is announced, a holder of securities or its agent requests such Ticket. When an actual conversion is possible, old securities and a Securities Ticket are converted (shares are split).

If the split is pending, and only a part of securities is sold, then the Conversion Securities Ticket is divided in two. One, which represents a sold portion of securities is transferred to a buyer, the other, which represents the left portion of securities, stays with the seller. Consequently, a buyer presents these (old) securities with a Ticket to an appropriate party for conversion. (This operation should be done automatically by a buyer's broker).

A subject of a dividend payment is a holding in a particular moment in past. A Dividend Securities Ticket is a kind of a “divisible” insurance policy. Often, there is a need in a special party, which issues Dividend Securities Tickets, receives dividends from a dividends payee, and converts presented Dividend Securities Tickets into dividends.

In a moment, when a dividend is announced, a holder of securities of a proper record requests a Dividend Securities Ticket. With such request, this securities holder forfeits his rights to receive this particular dividend payment directly and can receive this payment only indirectly in exchange for this Ticket.

This Ticket can be divided and sold (transferred). There are obvious limitations on how it can be divided. In many cases, each Dividend Securities Ticket represents dividends paid for a whole number of securities or it can only represent a whole number of units of the dividend payment (for example when dividend is paid in shares). Sometimes, more fine divisibility can be allowed, for example when dividends are paid in cash.

A buyer of a Dividend Securities Ticket can receive an appropriate dividend payment in exchange for this Ticket, when such payment can be made.

A Dividend Securities Ticket carries:

information about a record of securities holding in an appropriate moment, which is used to qualify for dividend payment (for example a unique id of such record)

a moment of dividend payment (an activation moment)

actual types and amounts of holdings of the dividend payment represented by this particular Ticket.

It can carry also additional information.

Securities Tickets are short lived. They exist from the moment a conversion or a dividend is announced to the moment, when an actual transaction is possible. Hence, they are mostly useful in electronic trade. Particularly, they are useful, when they can be in electronic form without any other representation.

Practically, Securities Tickets should be used with automatically monitored securities Accounts.

In this case, each Securities Ticket is tied to two Notifications.

First Notification indicates the moment, when it can be acquired, and it should be immediately followed by an actual acquisition of it.

Second Notification indicates the moment, when it can be converted (together with securities in the case of Conversion Securities Ticket). It should be immediately followed by an actual transaction, when such conversion is made.

If for some reason, these Notifications are missed or appropriate transactions cannot be executed, this should be handled as an exception and it should be a special procedure in place to handle it. Otherwise, one has to implement handling of chains of conversions and dividends on dividends.

When a trade has to be executed between two Accounts, where a first one supports Securities Tickets and another does not support them, all transactions related to Securities Tickets have to be finished by the first Account, before such trade is available.

It is possible to implement an aggregation of Securities Tickets of the same type, which belong to the same Account.

When Securities Tickets are moved between Accounts in the same system, where they are controlled by the same organization and integrity of transactions can be assured, they are implemented as an accounting procedure.

Otherwise, there is a need in a third party, which issues Securities Tickets, facilitates their division and aggregation, participates in each Tickets transfer and provides proper conversions and dividend payments, when Tickets are presented.

In this case, an id of an Account of a Ticket holder has to be a part of the Ticket's record.

This third party cryptographically signs each Securities Ticket, which it provides:

an original one,

replacement Securities Tickets, which it provides as a result of division of a Ticket presented for a division

a replacement Securities Ticket, which it provides as a result of aggregation of Tickets presented for an aggregation

a Ticket, which is transferred from one Account to the other without a division.

Following is a preferred implementation of Security Tickets.

An organization, which holds securities or currency in behalf of its customers in their Accounts and which allows its customers to trade their holdings between themselves, introduces Securities Tickets as a financial instrument available for trade between these Accounts.

Account information is held in a database, which is updated with each trade.

Customers can examine the state of their account and request execution of trades between themselves.

There are special software modules—Ticket Managers, which manage Securities Tickets; each Ticket Manager for its group of Accounts.

When this organization learns with a degree of assurance about a pending security or currency conversion or a dividend payment for a particular security, it issues a First Notification. As a result, all affected Accounts (Accounts, which hold a subject of conversion security or currency, or which have a history of holding qualifying for a dividend payment) are updated by their Ticket Managers with additional records appropriate Securities Tickets.

These records can be examined by Account holders. Account holders can query the system about possible variants of division of their Dividend Securities Tickets.

When Account holders engage in trade, which includes Securities Tickets, an appropriate Ticket Manager divides Securities Tickets as requested (if it is possible), and aggregates Securities Tickets, if needed.

When this organization is ready for a security or currency conversion or a dividend payment for a particular security, it issues a Second Notification. Consequently, all affected Accounts (Accounts, which hold this particular type of a Securities Ticket) are updated by their Ticket Managers—a conversion is made or a dividend is added to an Account.

All operations are executed as transactions.

1. A divisible financial instrument—a Securities Ticket, associated with a particular type of holding—a security or a currency, which
represents a particular “transformation in a progress” of this holding initiated by an issuer of this type of holding, for example as securities split, currency conversion, dividend payment, etc.
is granted to a holder of this holding before the end of the process of transformation
serves as a record used to finalize the transformation
participates in the trade of this holding as a representative of the state of this holding after this transformation.

2. The Securities Ticket of the claim 1—a Conversion Securities Ticket, which is associated with security or currency conversion, and which is split, as the associated with it holding is split when a part of the holding is transferred, and transferred together with that part of the holding; it carries information about the type of holding, which is a subject of transformation, and about the moment and the kind of this transformation.

3. The Securities Ticket of the claim 1—a Dividend Securities Ticket, which is associated with adding of holdings on the basis of a qualified historical record of an Account, where this holding is recorded, for example with a dividend or an interest payment, and which can be split (subject to limitations of such split) and transferred separately, for example as a part of a trade; it carries information about the qualified historical record, types and amounts of additional holdings due in the end of the transformation an the moment of this transformation.

4. The method of the claim 1 , where
securities or currency holding is represented as records in Accounts there are software modules—Tickets Managers, each managing its group of Accounts by granting Securities Tickets, performing their splits and aggregation and finalizing the transformation
there is a First Notification sent to Ticket Managers preceding a Securities Ticket granting and a Second Notification sent to Ticket Managers preceding a final holding transformation

5. The method of the claim 1, where there is a special entity, which
facilitates a delivery of a new version of a converted holding or a dividend or an interest payment
participates in creation of Securities Tickets, created as original Securities Tickets or as a result of Securities Tickets splits or a result of Securities Tickets aggregation.

6. The method of the claim 5, where each Securities Ticket is cryptographically signed by this entity.
